(19) United States
(12) Patent Application Publication
(10) Pub. No.: US 2022/0377131 A1
(43) Pub. Date: Nov. 24, 2022

(54) HYPERSCALE CLOUD PROVIDER (HCP) EDGE INTERWORKING WITH MULTIPLE PROTOCOL DATA UNIT (PDU) SESSIONS

(71) Applicant: Telefonaktiebolaget LM Ericsson (publ), Stockholm (SE)

(72) Inventors: Laszlo SZILAGYI, San Francisco, CA (US); Jan BACKMAN, KÄRNA (SE)

(73) Assignee: Telefonaktiebolaget LM Ericsson (publ), Stockholm (SE)

(21) Appl. No.: 17/664,859

(22) Filed: May 24, 2022

Related U.S. Application Data
(60) Provisional application No. 63/192,268, filed on May 24, 2021.

(51) Int. Cl. H04L 67/10

(52) U.S. Cl. CPC H04L 67/10

(57) ABSTRACT

A method performed by one or more network devices of a cloud platform for providing interworking between the cloud platform and a communication service platform. The method includes receiving, from a user of the cloud platform, input regarding desired characteristics for an edge cloud, providing, via an application programming interface, an indication of the desired characteristics for the edge cloud to the communication service platform, receiving, from the communication service platform via the application programing interface, an indication of a set of edge locations that is capable of supporting the desired characteristics for the edge cloud, provisioning an edge subnet at each edge location in the set of edge locations, and making the edge subnets visible to the user of the cloud platform.

### CROSS-REFERENCE TO RELATED APPLICATIONS

This application claims the benefit of U.S. Provisional Application No. 63/192,268, filed May 24, 2021, which is hereby incorporated by reference.

### TECHNICAL FIELD

Embodiments of the invention relate to the field of communication networks, and more specifically, to providing interworking between a cloud platform and a communication service platform.

### BACKGROUND

Cloud computing refers to the on-demand delivery of computing resources, typically over a network (e.g., the Internet) with pay-as-you-go pricing. For example, instead of buying, owning, and maintaining physical data centers and servers, a user may access computing resources such as computing power, storage, and databases, on an as-needed basis from a cloud provider.

A communication service provider/platform (CSP) may offer telecommunications services or some combination of information and media services, content, entertainment and application services over networks, leveraging the network infrastructure as a rich, functional platform. A CSP may own and/or operate a mobile network such as a Fourth Generation (4G) Long-term Evolution (LTE) mobile network and/or a Fifth Generation (5G) mobile network.

A hyperscale cloud platform (HCP) is a multi-tenant platform where computing, network, and storage resources can be accessed by multiple tenants on demand. HCP developer ecosystems are potent channels for communication service providers/platforms to monetize their mobile networks (e.g., 5G mobile network) assets. For example, communication service providers/platforms may deploy HCP edge infrastructures inside their mobile network premises to provide mobile edge computing services (an example of this is Amazon Web Services (AWS) Wavelength).

Some communication service providers/platforms are planning to integrate with HCPs to monetize the capabilities provided by their mobile networks. HCP edge infrastructures may enable developers to deploy workloads on the “edge” of mobile networks, thereby reducing latency between client applications running on (mobile) client devices and server applications.

An application developer may use an HCP portal (e.g., an AWS virtual private cloud (VPC) page) to create a virtual private cloud. A virtual private cloud is a virtual network provided by a cloud platform that is logically isolated from other virtual networks provided by the cloud platform. The application developer may provision subnets in the virtual private cloud at various edge locations within a mobile network to enable low latency edge computing. A subnet may be a range of IP addresses in the virtual private cloud.

Currently, application developers have to manually select the edge locations when configuring their virtual private clouds. This approach is viable when the number of edge locations is small. However, the number of edge locations in mobile networks is expected to increase significantly in the coming years. As the number of edge locations increase, it will be possible to deploy different applications having different latency and availability demands in different subsets of edge locations. In these scenarios, selecting the appropriate edge locations to fulfill the application demands might be difficult.

### SUMMARY

A method performed by one or more network devices of a cloud platform for providing interworking between the cloud platform and a communication service platform. The method includes receiving, from a user of the cloud platform, input regarding desired characteristics for an edge cloud, providing, via an application programming interface, an indication of the desired characteristics for the edge cloud to the communication service platform, receiving, from the communication service platform via the application programing interface, an indication of a set of edge locations that is capable of supporting the desired characteristics for the edge cloud, provisioning an edge subnet at each edge location in the set of edge locations, and making the edge subnets visible to the user of the cloud platform.

A set of non-transitory machine-readable media having computer code stored therein, which when executed by one or more processors of one or more network devices of a cloud platform, causes the one or more network devices to perform operations for providing interworking between the cloud platform and a communication service platform. The operations include receiving, from a user of the cloud platform, input regarding desired characteristics for an edge cloud, providing, via an application programming interface, an indication of the desired characteristics for the edge cloud to the communication service platform, receiving, from the communication service platform via the application programing interface, an indication of a set of edge locations that is capable of supporting the desired characteristics for the edge cloud, provisioning an edge subnet at each edge location in the set of edge locations, and making the edge subnets visible to the user of the cloud platform.

A method performed by one or more network devices of a communication service platform for providing interworking between a cloud platform and the communication service platform. The method includes receiving, from the cloud platform via an application programming interface, an indication of desired characteristics for an edge cloud, wherein the desired characteristics for the edge cloud were provided to the cloud platform by a user of the cloud platform, determining a network slice that is capable of supporting the desired characteristics for the edge cloud, determining a set of edge locations associated with the network slice, creating a user equipment route selection policy (URSP) rule that associates a traffic descriptor with the network slice, and providing, to the cloud platform via the application programming interface, an indication of the set of edge locations.

A set of non-transitory machine-readable media having computer code stored therein, which when executed by one or more processors of one or more network devices of a communication service platform, causes the one or more network device to perform operations for providing interworking between a cloud platform and the communication service platform. The operations include receiving, from the cloud platform via an application programming interface, an indication of desired characteristics for an edge cloud, wherein the desired characteristics for the edge cloud were provided to the cloud platform by a user of the cloud platform, determining a network slice that is capable of supporting the desired characteristics for the edge cloud, determining a set of edge locations associated with the network slice, creating a user equipment route selection policy (URSP) rule that associates a traffic descriptor with the network slice, and providing, to the cloud platform via the application programming interface, an indication of the set of edge locations.

### BRIEF DESCRIPTION OF THE DRAWINGS

The invention may best be understood by referring to the following description and accompanying drawings that are used to illustrate embodiments of the invention. In the drawings:

FIG. 1 is a diagram showing an environment in which interworking between a cloud platform and a communication service platform can be implemented, according to some embodiments.

FIG. 2 is a diagram showing network slice configurations, according to some embodiments.

FIG. 3A is a diagram showing component interactions for providing interworking between a cloud platform and a communication service platform using a static network slice selection approach, according to some embodiments.

FIG. 3B is a diagram showing component interactions for providing interworking between a cloud platform and a communication service platform using a dynamic network slice generation approach, according to some embodiments.

FIG. 4 is a flow diagram showing a method performed by a cloud platform for providing interworking between the cloud platform and a communication service platform, according to some embodiments.

FIG. 5 is a flow diagram showing a method performed by a communication service platform for providing interworking between a cloud platform and the communication service platform, according to some embodiments.

FIG. 6 is a diagram showing an example of a communication system, according to some embodiments.

FIG. 7 is a diagram showing a user equipment (UE), according to some embodiments.

FIG. 8 shows a network node, according to some embodiments.

FIG. 9 is a block diagram of a host, according to some embodiments.

FIG. 10 is a block diagram showing a virtualization environment in which functions implemented by some embodiments may be virtualized.

FIG. 11 is a communication diagram showing a host communicating via a network node with a UE over a partially wireless connection, according to some embodiments.

### DETAILED DESCRIPTION

The following description describes methods and apparatus for providing interworking between a cloud platform and a communication service platform. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

As mentioned above, manual selection of edge locations is a viable approach for cloud users designing virtual private clouds when the number of edge locations is small. However, the number of edge locations in mobile networks is expected to increase significantly in the coming years. As the number of edge locations increase, it will be possible to deploy different applications having different latency and availability demands in different subsets of edge locations. In these cases, selecting the appropriate edge locations that can fulfill the different application demands might not be straightforward.

As the number of edge locations increase, manual selection of edge locations will not be practical. An application might not need to be deployed at every edge location. The number of edge locations at which the application needs to be deployed may depend on the requirements of the application (e.g., latency requirements and geographics). It is foreseen by the present disclosure that application developers will need assistance in determining the edge locations at which to provision edge subnets for their virtual private clouds depending on application requirements.

To select the appropriate edge locations, an application developer would need to know the actual network performance characteristics of a large number of edge locations (e.g., using network measurement tools in the application) and then select/change the edge locations being used by the application (e.g., explicitly in the application) based on the network performance characteristics, which would unduly complicate the application. Also, communication service providers/platforms and hyperscale cloud providers/platforms might not want to share such detailed information regarding their infrastructures with application developers or with each other.

Embodiments disclosed herein provide solutions to these or other challenges. Embodiments leverage network slicing and multiple protocol data unit (PDU) sessions to fulfill service level agreements (SLA) and provide traffic steering to edge locations. From a workflow point of view, the approaches described herein can be considered as “VPC design-time SLA fulfilment” approaches that determine the edge locations at which to provision edge subnets for a virtual private cloud in a manner that specified SLAs are met. Then any workload deployed in such edge subnets may enjoy the specified SLAs. Embodiments achieve this using active interaction between the communication service provider/platform and cloud provider/platform.

According to some embodiments, a cloud platform receives user input (from a user of the cloud platform) regarding the desired characteristics for an edge cloud (e.g., via user selection of a “SLA tier” (e.g., “Bronze”/sub-100 millisecond latency, “Silver”/sub-50 millisecond latency, or “Gold”/sub-20 millisecond latency) and a geographic area (e.g., Texas)). The cloud platform provides an indication of the desired characteristics for the edge cloud to the communication service platform via an application programming interface (API). Responsive to receiving the indication of the desired characteristics for the edge cloud, the communication service platform determines a network slice that is capable of supporting the desired characteristics of the edge cloud (e.g., the specified SLA and geographic area). The communication service platform determines a set of edge locations associated with the network slice, creates a user equipment route selection policy (URSP) rule that associates a traffic descriptor with the network slice, and provides an indication of the set of edge locations to the cloud platform via the API. Responsive to receiving the indication of the set of edge locations, the cloud platform provisions an edge subnet at each edge location in the set of edge locations and makes the edge subnets visible to the cloud user. The cloud user may then deploy an application in the edge subnets.

In an embodiment, the traffic descriptor is a data network name (DNN). In such an embodiment, the communication service platform may provide the DNN to the cloud platform via the API. The cloud platform may then provide this DNN to the cloud user (e.g., display the DNN to the user via a graphical user interface (GUI)). The cloud user may use the DNN as a parameter in the client application for setting up the network socket to the application deployed in the edge cloud. A URSP mechanism may determine the network slice associated with the DNN and establish a PDU session for the client application that the client application can use to communicate with the application deployed in the edge cloud using the network slice.

In another embodiment, the traffic descriptor is a fully qualified domain name (FQDN) associated with the application deployed in the edge cloud. In such an embodiment, a URSP mechanism may determine the network slice associated with the FQDN and establish a PDU session for the client application that the client application can use to communicate with the application deployed in the edge cloud using the network slice.

Embodiments provide one or more advantages over existing solutions. An advantage of embodiments disclosed herein is that they provide simplicity for an application developer when configuring an edge cloud in which to deploy an application. The application developer does not have to be aware of the edge locations or network slicing, and does not have to perform network measurements to select the appropriate edge locations and network slices for an application.

Also, an advantage of embodiments is that they allow the application developer to rely on existing cloud platform workflows and best practices. For example, the application developer may design a virtual private cloud and deploy workloads into them, as usual. Also, the application developer may continue to use domain name system (DNS) and FQDNs to allow client applications to reach their applications, as usual.

Also, an advantage of embodiments is that they allow the communication service platform to hide away complexities and sensitive infrastructure information. The communication service platform does not have to openly expose detailed information about edge locations to application developers. Also, the communication service platform does not have to expose network slicing and edge location related APIs directly to application developers. Also, the communication service platform may optimize utilization by implementing load balancing mechanisms under the hood (e.g., using dynamically generated network slices, as will be described in additional detail herein).

Also, an advantage of embodiments is that they allow cloud platforms to hide away complexities and sensitive infrastructure information. A cloud platform does not have to directly share utilization information with the application developer or the communication service platform. Also, the cloud platform may leverage the existing developer ecosystem competence to provide a seamless developer experience. Embodiments are described in further detail herein below with reference to the accompanying figures.

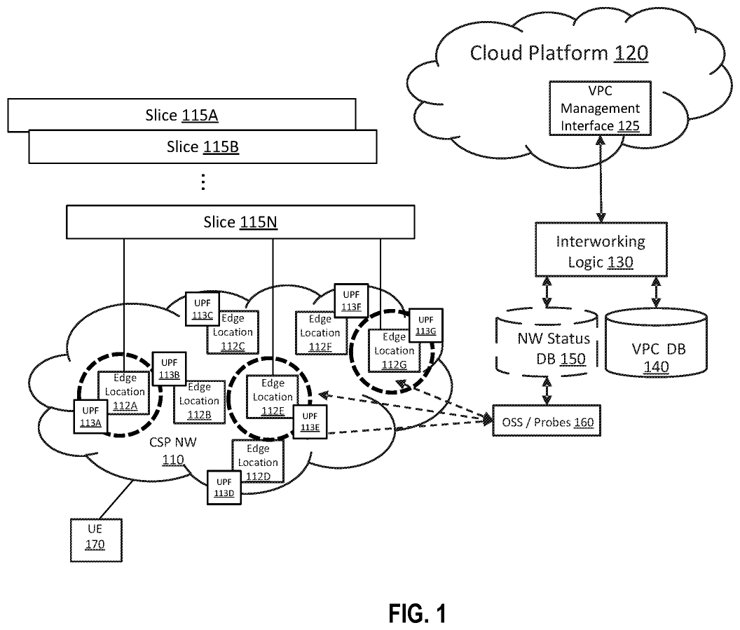

FIG. 1 is a diagram showing an environment in which interworking between a cloud platform and a communication service platform can be implemented, according to some embodiments. As shown in the diagram, the environment includes a communication service platform network (CSP NW) 110, a cloud platform 120, an interworking logic 130, a virtual private cloud database (VPC DB) 140, operation support systems (OSS)/probes 160, and a user equipment (UE) 170.

The communication service platform network 110 may offer communication services to users/subscribers. In an embodiment, the communication service platform network 110 is a Fourth Generation (4G) Long-term Evolution (LTE) mobile network and/or a Fifth Generation (5G) mobile network. The communication service platform network 110 may include multiple edge locations 112 (e.g., edge point of presence (PoP)). For example, as shown in the diagram, the communication service platform network 110 includes edge locations 112A-G.

The cloud platform 120 may include a collection of hardware and software resources that enable cloud computing. For example, the cloud platform 120 may include computing resources, networking resources, and/or storage resources, as well as an interface (e.g., a GUI) for cloud users to access virtualized resources. In an embodiment, the cloud platform 120 is a hyperscale cloud platform (HCP).

The UE 170 may be a network device that can communicate wirelessly with the communication service platform network 110. The UE 170 may be, for example, a mobile phone, a laptop, or similar device. The UE 170 may communicate wirelessly with the communication service platform network 110 to access an application deployed in the cloud platform 120 and/or the communication service platform network 110 (e.g., deployed at one of the edge locations 112A-G of the communication service platform network 110).

As shown in the diagram, the cloud platform 120 includes a virtual private cloud (VPC) management interface 125 (also referred to herein simply as “management interface”). A cloud user (e.g., an application developer) may use the management interface 125 (e.g., which might be implemented as a GUI that the cloud user accesses over a network) to create a virtual private edge cloud in the communication service platform network 110 and deploy an application in that edge cloud. In an embodiment, a cloud user provides input regarding the desired characteristics for an edge cloud to the cloud platform 120 via the management interface 125. The desired characteristics may include geographic location (e.g., a U.S. state (e.g., Texas) or metropolitan area), mobile operator (“all” could be an option), latency tier (sub-50 millisecond, sub-20 millisecond, sub-10 millisecond, etc.), guaranteed bit rate (10 Mbps, 20 Mbps, 50 Mbps, etc.), high availability (non-redundant could provide 99.5% availability and redundant pairs could provide 99.95% availability), mobility options and session continuity (e.g., session and service continuity (SSC) modes 2, 3, 4). The cloud platform 120 may then provide this user input to the interworking logic 130 (e.g., via an application programming interface (API) exposed by the interworking logic 130 towards the cloud platform 120). The interworking logic 130 may be a component of the communication service platform that provides interworking between the cloud platform 120 and the communication service platform. The interworking logic 130 may be implemented by one or more network devices of the communication service platform.

Responsive to receiving the desired characteristics for the edge cloud, the interworking logic 130 may send a request to the OSS/probes 160 to provide a network slice 115 that is capable of supporting the desired characteristics. Network slicing is a network architecture concept that enables the multiplexing of virtualized and independent logical networks on the same physical network infrastructure. Each network slice may be a logically isolated end-to-end network tailored to fulfill diverse requirements requested by a particular application.

In an embodiment, the communication service platform has preexisting network slices 115A-N. In an embodiment, the network slices 115A-N are preconfigured according to service level agreements (SLAs) (e.g., to fulfill different latency requirements such as sub-50 millisecond, sub-20 millisecond, and sub-10 millisecond tiers). Each network slice 115 may be associated with a set of edge locations 112 in the communication service platform network 110. For example, as shown in the diagram, network slice 115N is associated with edge locations 112A, 112E, and 112G. Each edge location 112 may implement a user plane function (UPF) 113 (or other type of user/data plane component) or be geographically proximate to a UPF 113. For example, as shown in the diagram, edge locations 112A, 112B, 112C, 112D, 112E, 112F, and 112G implement (or are otherwise geographically proximate to) UPFs 113A, 113B, 113C, 113D, 113E, 113F, and 113G, respectively. In general, a network slice 115 fulfilling a higher latency requirement (e.g., sub-50 millisecond latency) will typically be associated with a smaller number of UPFs/edge locations 113/112 compared to a network slice 115 fulfilling a lower latency requirement (e.g., sub-10 millisecond latency) in a given geography. The UPF selection policy for a network slice 115 may be configured such that UE 170 traffic terminates on the network slice's closest UPF 113.

Responsive to receiving the request from the interworking logic 130 to provide a network slice 115, the OSS/probes 160 may either select a preexisting network slice 115 that is capable of supporting the desired characteristics (referred to herein as a “static” network slice selection approach) or generate a new network slice 115 that is capable of supporting the desired characteristics (referred to herein as a “dynamic” network slice generation approach).

When using the static network slice selection approach, multiple users may share the same network slice 115 but it might be desirable to provide different bit rates, priority levels, and/or other type of quality of service (QoS) for different users sharing the same network slice 115. Thus, in an embodiment, the interworking logic 130 determines the QoS API parameters for a cloud user.

When using the dynamic network slice generation approach, the OSS/probes 160 may generate a new network slice 115 that is capable of supporting the desired characteristics provided by the cloud user based on network status information and/or a network slice template (e.g., there could be templates for different latency tiers). In an embodiment, the communication service platform maintains a network status database 150 that stores various network status information such as latency information and network capacity utilization information for UPFs 113 and/or edge locations 112 and the availability status of the edge locations 112 (e.g., whether there are network failures) for network slices 115.

The latency information may include latency estimates from tracking areas/cells to (relevant) UPFs 113 and/or latency estimates from UPFs to 113 interconnected edge nodes inside and/or outside the network infrastructure (e.g., multiple cloud platform nodes and external colocation centers with the cloud platform 120 and third-party provider (3PP) nodes (e.g., other edge platform providers beyond cloud platforms such as content distribution networking (CDN) players)). Latency measurements may be obtained by the OSS/network probes 160 or other suitable means. If real-time latency measurements are not possible or practical to obtain, a static database can be used based on dedicated (“day zero”) or historical latency measurements. Network capacities may be measured using UPFs 113 and/or other network gear functions or by dedicated probes. Although the diagram shows the network status database 150 as being separate from the OSS/probes 160, in some embodiments, the network status database 150 is integrated with the OSS/probes 160. In an embodiment, traffic patterns that are specific to the cloud user are determined/collected and stored in the network status database 150 to help optimize edge location selection in case a cloud user expands its existing solution.

Once the OSS/probes 160 selects or generates a network slice 115, the OSS/probes 160 may provide information about the selected or created network slice 115 to the interworking logic 130. The interworking logic 130 may determine the set of edge locations 112 associated with the network slice 115 and provide an indication of the set of edge locations 112 associated with the network slice 115 to the cloud platform 120. In an embodiment, the interworking logic 130 “negotiates” (e.g., at an API level) with the cloud platform 120 regarding the set of edge locations 112 until an agreement is reached.

Responsive to receiving the indication of the set of edge locations 112 associated with the network slice 115, the cloud platform 120 may provision an edge subnet at each edge location in the set of edge locations 112 and make these edge subnets visible to the cloud user (e.g., such that the edge subnets are visible to the cloud user in the management interface 125). The cloud user may then use the management interface 125 to deploy an application in the edge subnets (which effectively deploys the application in the edge cloud).

The cloud user may create/update a DNS record for a FQDN associated with the application it deployed in the edge cloud. The DNS record may include the IP addresses of the application instances deployed in the edge cloud. The DNS record may be created in the cloud platform's 120 DNS service.

In an embodiment, a URSP rule is created that associates a traffic descriptor with the selected/created network slice 115. In an embodiment, the traffic descriptor is a data network name (DNN). In such an embodiment, the interworking logic 130 (or other component of the communication service platform) may create the URSP rule in the communication service platform when the network slice 115 is selected/created. In an embodiment, the interworking logic 130 provides the DNN associated with the selected/created network slice 115 to the cloud platform 120 (e.g., together with the indication of the set of edge locations 112 associated with the network slice 115). The cloud platform 120 may provide this DNN to the cloud user (e.g., by displaying the DNN in the management interface 125). As will be described in further detail herein below, the cloud user may use the DNN as a parameter in a client application for setting up the network socket to the application deployed in the edge cloud. In an embodiment, the traffic descriptor is a FQDN associated with the application. In such an embodiment, the DNS service of the cloud platform 120 may interact with the communication service platform to create the URSP rule in the communication service platform (e.g., at the time when the DNS record for the FQDN is created in the DNS service of the cloud platform 120).

In an embodiment, the interworking logic 130 creates a record for the cloud user in the VPC database 140. The record for the cloud user may indicate the network slice 115 that was selected/created for the cloud user, which edge locations 112 are associated with the network slice 115, the URSP rule, and/or QoS parameters. This record may be used for Internet Protocol (IP) address allocation and routing requests API for the cloud platform 120.

For network slicing to take effect, the UE 170 implementing the client application should support multiple PDU sessions (e.g., different PDU sessions for different network slices 115) and have downloaded the relevant URSP configurations. Since the cloud user might not know which UEs 170 will access its edge cloud application in advance, a UE bootstrapping mechanism may be provided. The UE bootstrapping mechanism may be implemented by introducing a “UE bootstrapping API” pointing to a bootstrap server uniform resource locator (URL) which the client application would invoke at the first time the edge cloud application is accessed (e.g., during authentication stage).

The bootstrap server may call the “AF Influence PCF decisions for URSP” API to trigger a policy control function (PCF) configuration and a UE configuration update to push the relevant URSP rule (e.g., that associates the DNN or FQDN with the selected/generated network slice 115) to the UE 170 accessing the edge cloud application. The bootstrap server may extract the UE IP address to parameterize the API (the “UE Information API” can also be used). With the relevant URSP rule downloaded, the UE 170 (and specifically the client application implemented by the UE 170) can access the edge cloud application via the selected/generated network slice 115 and the additional PDU session. In an embodiment, the bootstrap server may use a similar mechanism to trigger dynamic QoS configuration for the UE 170 (the pre-existing network slices 115 may be shared resources so the guaranteed bit rate may be secured with 5G QoS identifier (5QI) leveraging the dynamic QoS API—for each network slice 115 the appropriate quality classes may be preconfigured according to bandwidth tiers (e.g., 10 Mbps, 20 Mbps, 50 Mbps, etc.)).

The cloud user may configure the client application to use the specified DNN/alias in the IP socket setup API to set up the connectivity towards the closest edge server. Another option to provide UE bootstrapping is to integrate the UE bootstrapping API call into the client IP socket setup API (to download the relevant URSP rule(s)). If the IP socket configuration is not possible with the specified DNN/alias first, the reason might be the lack of UE bootstrapping which can then be triggered.

Thus, the interworking logic 130 allows the cloud platform 120 to interact with the communication service platform to determine the edge locations 112 at which to provision edge subnets to achieve the desired characteristics for the edge cloud. A UE bootstrapping mechanism may configure the UEs 170 implementing a client application to access an application deployed in the edge cloud using the appropriate network slice 115 (with UE traffic terminating at the closest UPF 113 to the UE 170).

While a certain arrangement of components is shown in the diagram to illustrate a particular embodiment, it should be understood that other embodiments may include different components and/or have a different arrangement of components to achieve the same/similar functionality.

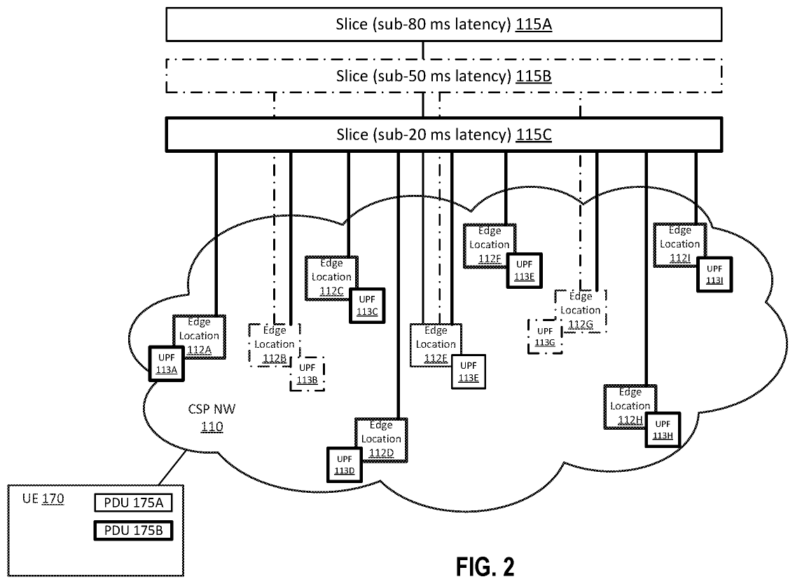

FIG. 2 is a diagram showing network slice configurations, according to some embodiments. Three network slices, namely network slice 115A, network slice 115B, and network slice 115C, are shown in the diagram. Different network slices 115 may provide different levels of latency. In general, a network slice 115 that is associated with more edge locations 112 (or UPFs 113) provides lower latency. For example, network slice 115A provides sub-80 millisecond latency and is associated with a single edge location 112E (e.g., implementing UPF 113E), network slice 115B provides sub-50 millisecond latency and is associated with edge locations 112B, 112E, and 112G (e.g., implementing UPFs 113B, 113E, and 113G, respectively), and network slice 115C provides sub-20 millisecond latency and is associated with edge locations 112A, 112B, 112C, 112D, 112E, 112F, 112G, 112H, and 112I (e.g., implementing UPFs 113A, 113B, 113C, 113D, 113E, 113F, 113G, 113H, and 113I, respectively).

A UE 170 may have multiple PDU sessions 175 that are each associated with a different network slice 115. For example, as shown in the diagram, the UE 170 may have a PDU session 175A associated with network slice 115A and a PDU session 175B associated with network slice 115C. The UE 170 may use PDU session 175A to communicate using network slice 115A and use PDU session 175B to communicate using network slice 115C.

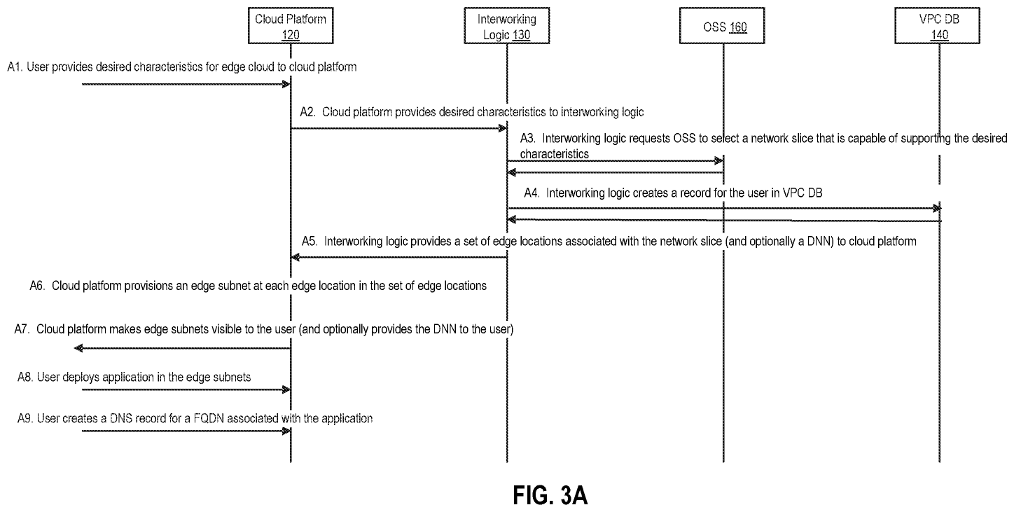

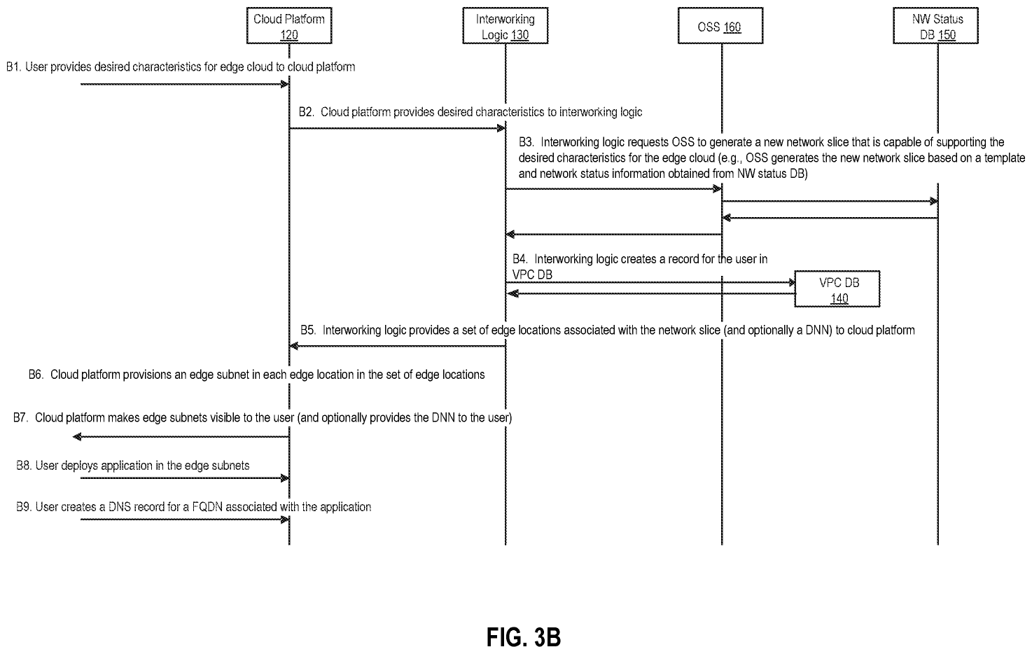

FIG. 3A is a diagram showing component interactions for providing interworking between a cloud platform and a communication service platform using a static network slice selection approach, according to some embodiments.

With this approach, SLA tiers (e.g., sub-50 millisecond, sub-20 millisecond, sub-10 millisecond, etc.) may be preconfigured by the communication service platform as network slices. There may be pre-selected UPFs for each of the SLA tiers (e.g., which are next to edge cloud nodes). The network slices may be reused/shared by multiple users. QoS APIs may be used for further SLA parameterization (e.g., to provide guaranteed bit rate).

As shown in the diagram, at operation A1, a cloud user provides desired characteristics for an edge cloud to the cloud platform 120 (e.g., the user selects the sub-50 millisecond latency tier for the Texas geography). At operation A2, the cloud platform provides the desired characteristics to the interworking logic 130 (e.g., via an API exposed by the interworking logic 130 towards the cloud platform). At operation A3, the interworking logic 130 sends a request to the OSS 160 to select a network slice that is capable of supporting the desired characteristics. In response, the OSS 160 selects the network slice (from a set of preexisting network slices) and provides information regarding the selected network slice to the interworking logic 130. At operation A4, the interworking logic 130 creates a record for the cloud user in the VPC database 140. The record may include information regarding the network slice that was selected, which edge locations are associated with the network slice, a URSP rule, and/or QoS parameters. At operation A5, the interworking logic 130 provides a set of edge locations associated with the network slice (and optionally a DNN) to the cloud platform 120 (e.g., via the API). At operation A6, the cloud platform 120 provisions an edge subnet at each edge location in the set of edge locations. At operation A7, the cloud platform makes the edge subnets visible to the user (and optionally provides the DNN to the user) (e.g., via the management interface 125). At operation A8, the cloud user deploys an application in the edge subnets (e.g., as auto scale groups) to create an “edge cloud” application. At operation A9, the user creates a DNS record for a FQDN associated with the application.

In an embodiment, the cloud user configures the client network socket setup in the client application to use the provided DNN (or alias) as a parameter along with the application's FQDN. A UE bootstrapping mechanism and URSP mechanism may be used to set up the PDU session in the UE, as described above. The UE's network traffic pertaining to the client application may be routed via the closest UPF within the network slice according to the routing policy. The cloud platform's DNS service (e.g., which may be implemented by a proxy in a cloud platform edge node) resolves the FQDN and returns the IP address of the application deployed in the edge cloud. No smart DNS integration with the network is necessary.

FIG. 3B is a diagram showing component interactions for providing interworking between a cloud platform and a communication service platform using a dynamic network slice generation approach, according to some embodiments.

With this approach, there may be SLA-specific templates for network slices (e.g., for sub-50 millisecond latency, sub-20 millisecond latency, sub-10 millisecond latency, etc.) but the network slices are not provisioned up front as with the static network slice selection approach. Instead, the templates may be used to generate and provision network slices on demand. This enables dynamic on-the-fly selection of UPFs at edge locations that leverage real-time and/or historical network statistics. This may also allow for “negotiating” with the cloud platform regarding edge locations (e.g., on an API level).

As shown in the diagram, at operation B1, a cloud user provides desired characteristics for an edge cloud to the cloud platform 120 (e.g., the user selects the sub-50 millisecond latency tier for the Texas geography). At operation B2, the cloud platform provides the desired characteristics to the interworking logic 130 (e.g., via an API exposed by the interworking logic 130 towards the cloud platform). At operation B3, the interworking logic 130 sends a request to the OSS 160 to generate a new network slice that is capable of supporting the desired characteristics. In response, the OSS 160 generates a new network slice using a template and real time and/or historical network statistics data (which may be accessed from the network status database 150). Optionally, the communication service platform provides multiple options to the cloud platform 120 to choose from (to allow for “negotiations”), and then generates the new network slice based on the result of the negotiation with the cloud platform 120. The OSS 160 may provide information regarding the newly generated network slice to the interworking logic 130. At operation B4, the interworking logic 130 creates a record for the cloud user in the VPC database 140. The record may include information regarding the network slice that was generated, which edge locations are associated with the network slice, a URSP rule, and/or QoS parameters. At operation B5, the interworking logic 130 provides a set of edge locations associated with the network slice (and optionally a DNN) to the cloud platform 120 (e.g., via the API). At operation B6, the cloud platform 120 provisions an edge subnet at each edge location in the set of edge locations. At operation B7, the cloud platform makes the edge subnets visible to the user (and optionally provides the DNN to the user) (e.g., via the management interface 125). At operation B8, the cloud user deploys an application in the edge subnets (e.g., as auto scale groups) to create an “edge cloud” application. At operation B9, the cloud user creates a DNS record for a FQDN associated with the application.

The configuration of the UE and client application may be the same or similar to that described above with regard to FIG. 3A, and thus is not repeated here for sake of conciseness.

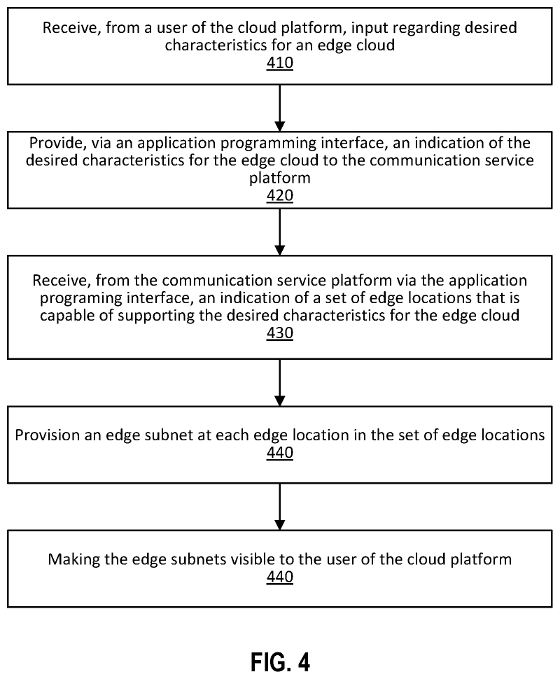

FIG. 4 is a flow diagram showing a method performed by a cloud platform for providing interworking between the cloud platform and a communication service platform, according to some embodiments. The method may be implemented using hardware, software, or a combination thereof.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

At operation 410, the cloud platform receives, from a user of the cloud platform, input regarding desired characteristics for an edge cloud. In an embodiment, the desired characteristics for the edge cloud include one or more of: a desired geographical location, a desired latency tier, and a desired bit rate tier.

At operation 420, the cloud platform provides, via an API, an indication of the desired characteristics for the edge cloud to the communication service platform.

At operation 430, the cloud platform receives, from the communication service platform via the API, an indication of a set of edge locations that is capable of supporting the desired characteristics for the edge cloud. In an embodiment, the cloud platform also receives from the communication service platform via the API, a DNN and provides the DNN to the user of the cloud platform.

At operation 440, the cloud platform provisions an edge subnet at each edge location in the set of edge locations.

At operation 450, the cloud platform makes the edge subnets visible to the user of the cloud platform.

In an embodiment, the cloud platform creates a DNS record for a FQDN associated with an application to be deployed in the edge cloud. In an embodiment, the cloud platform provides the FQDN associated with the application to the communication service platform, wherein the communication service platform is to create a URSP rule that associates the FQDN with a network slice associated with the set of edge locations. In an embodiment, the cloud platform provides a bootstrapping mechanism that is to cause a URSP rule to be pushed to a UE when the UE accesses an application deployed in the edge cloud. With the bootstrapping mechanism in place, the user of the cloud platform (e.g., an application developer) does not need to specify the user subscriptions in advance—it is enough if the client application (implemented by the UE) authenticates itself towards a bootstrap server (e.g., using the credentials associated with a particular edge configuration and/or network slice) and that is sufficient to identify the appropriate URSP rule to be pushed to the UE.

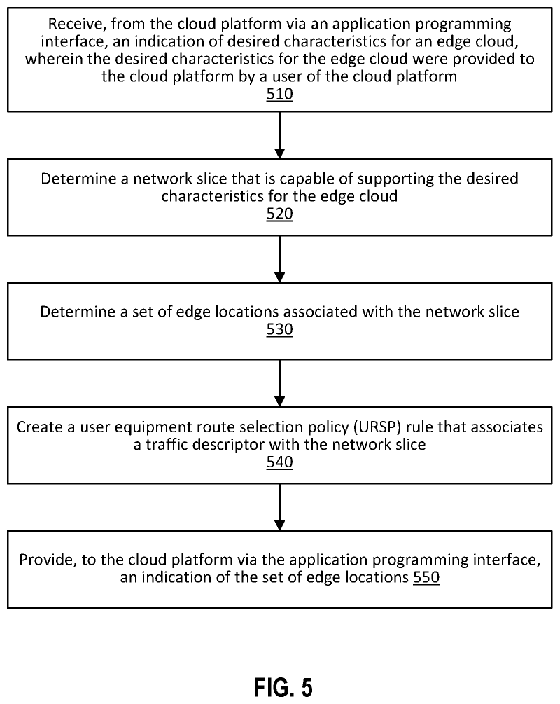

FIG. 5 is a flow diagram showing a method performed by a communication service platform for providing interworking between a cloud platform and the communication service platform, according to some embodiments. The method may be implemented using hardware, software, or a combination thereof.

At operation 510, the communication service platform receives, from the cloud platform, an indication of desired characteristics for an edge cloud, wherein the desired characteristics for the edge cloud were provided to the cloud platform by a user of the cloud platform.

At operation 520, the communication service platform determines a network slice that is capable of supporting the desired characteristics for the edge cloud. In an embodiment, the network slice is determined based on selecting the network slice from a plurality of existing network slices. In an embodiment, the network slice is determined based on generating a new network slice. In an embodiment, the new network slice is generated based on network status information obtained from a network status database and/or a network slice template.

At operation 530, the communication service platform determines a set of edge locations associated with the edge cloud.

At operation 540, the communication service platform creates a URSP rule that associates a traffic descriptor with the network slice. In an embodiment, the traffic descriptor is a DNN. In an embodiment, the communication service platform provides the DNN to the cloud platform via the API. In an embodiment, the traffic descriptor is a FQDN (that is associated with an application that is deployed or to be deployed in the edge cloud).

At operation 550, the communication service platform provides, to the cloud platform via the API, an indication of the set of edge locations.

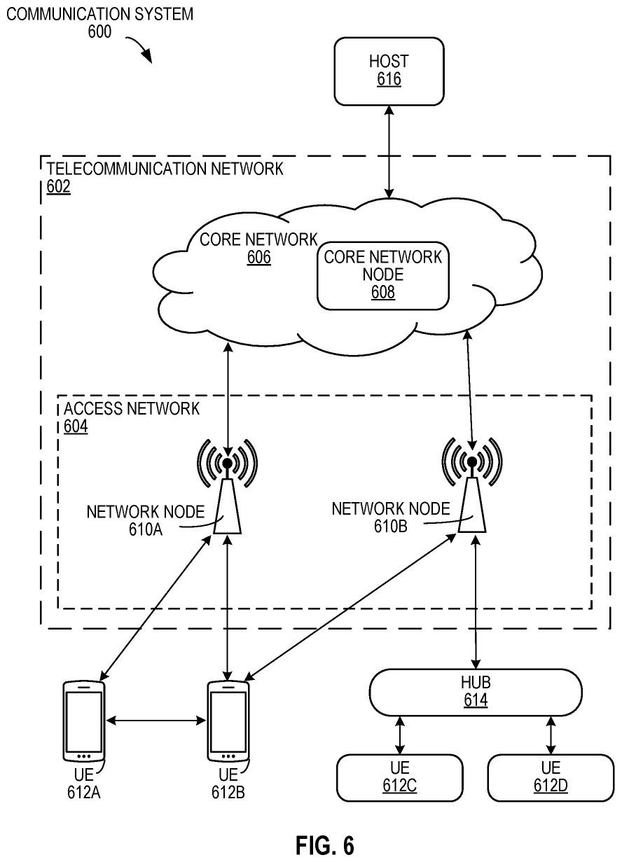

FIG. 6 is a diagram showing an example of a communication system, according to some embodiments.

In the example, the communication system 600 includes a telecommunication network 602 that includes an access network 604, such as a radio access network (RAN), and a core network 606, which includes one or more core network nodes 608. The access network 604 includes one or more access network nodes, such as network nodes 610a and 610b (one or more of which may be generally referred to as network nodes 610), or any other similar 3^{rd} Generation Partnership Project (3GPP) access node or non-3GPP access point. The network nodes 610 facilitate direct or indirect connection of user equipment (UE), such as by connecting UEs 612a, 612b, 612c, and 612d (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602, and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 602 is a cellular network that implements 3GPP standardized features. Accordingly, the telecommunications network 602 may support network slicing to provide different logical networks to different devices that are connected to the telecommunication network 602. For example, the telecommunications network 602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 614 communicates with the access network 604 to facilitate indirect communication between one or more UEs (e.g., UE 612c and/or 612d) and network nodes (e.g., network node 610b). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a VR headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular in if one or more of the UEs are low energy IoT devices.

The hub 614 may have a constant/persistent or intermittent connection to the network node 610b. The hub 614 may also allow for a different communication scheme and/or schedule between the hub 614 and UEs (e.g., UE 612c and/or 612d), and between the hub 614 and the core network 606. In other examples, the hub 614 is connected to the core network 606 and/or one or more UEs via a wired connection. Moreover, the hub 614 may be configured to connect to an M2M service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610b. In other embodiments, the hub 614 may be a non-dedicated hub—that is, a device which is capable of operating to route communications between the UEs and network node 610b, but which is additionally capable of operating as a communication start and/or end point for certain data channels.

In an embodiment, the telecommunication network 602 includes an interworking logic 130 (and possibly other components) to provide interworking between a cloud platform 120 and a communication service platform, as described herein.

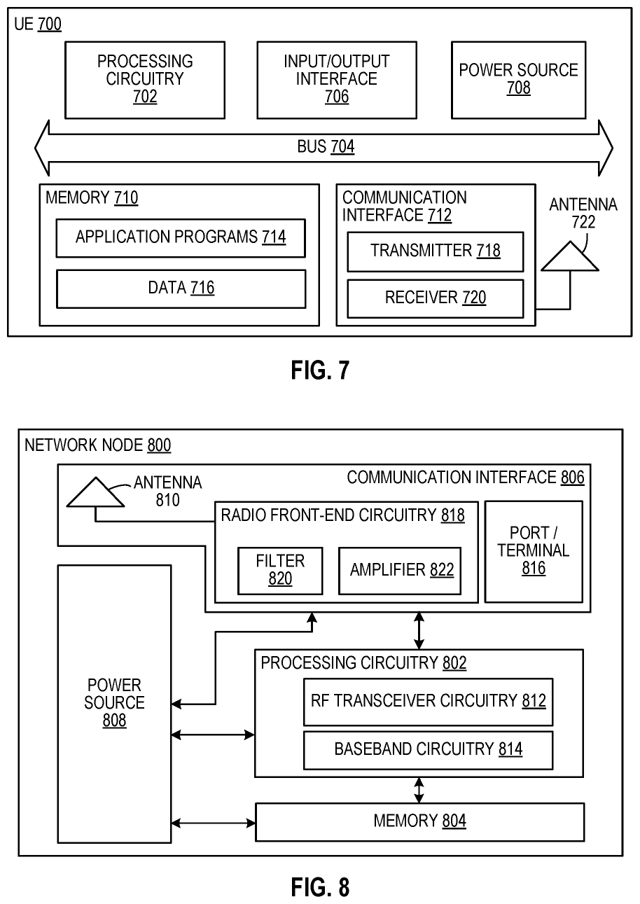

FIG. 7 is a diagram showing a UE, according to some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, a memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 702 may include multiple central processing units (CPUs).

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging of the power source 708. Power circuitry may perform any formatting, converting, or other modification to the power from the power source 708 to make the power suitable for the respective components of the UE 700 to which power is supplied.

The memory 710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM other memory, or any combination thereof. The UICC may for example be an embedded UICC (eUICC), integrated UICC (iUICC) or a removable UICC commonly known as ‘SIM card.’ The memory 710 may allow the UE 700 to access instructions, application programs and the like, stored on transitory or non-transitory memory media, to off-load data, or to upload data. An article of manufacture, such as one utilizing a communication system may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., antenna 722) and may share circuit components, software or firmware, or alternatively be implemented separately.

In the illustrated embodiment, communication functions of the communication interface 712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 700 shown in FIG. 7.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

In an embodiment, the UE 700 implements a client application that can access an application deployed in a cloud platform or an edge cloud.

FIG. 8 shows a network node, according to some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes a processing circuitry 802, a memory 804, a communication interface 806, and a power source 808. The network node 800 may be composed of multiple physically separate components (e.g., a NodeB component and a RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 800 may be configured to support multiple radio access technologies (RATs). In such embodiments, some components may be duplicated (e.g., separate memory 804 for different RATs) and some components may be reused (e.g., a same antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 800.

The processing circuitry 802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 800 components, such as the memory 804, to provide network node 800 functionality.

In some embodiments, the processing circuitry 802 includes a system on a chip (SOC). In some embodiments, the processing circuitry 802 includes one or more of radio frequency (RF) transceiver circuitry 812 and baseband processing circuitry 814. In some embodiments, the radio frequency (RF) transceiver circuitry 812 and the baseband processing circuitry 814 may be on separate chips (or sets of chips), boards, or units, such as radio units and digital units. In alternative embodiments, part or all of RF transceiver circuitry 812 and baseband processing circuitry 814 may be on the same chip or set of chips, boards, or units.

The memory 804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and memory 804 is integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. Radio front-end circuitry 818 comprises filters 820 and amplifiers 822. The radio front-end circuitry 818 may be connected to an antenna 810 and processing circuitry 802. The radio front-end circuitry may be configured to condition signals communicated between antenna 810 and processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of filters 820 and/or amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface may comprise different components and/or different combinations of components.

In certain alternative embodiments, the network node 800 does not include separate radio front-end circuitry 818, instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes one or more ports or terminals 816, the radio front-end circuitry 818, and the RF transceiver circuitry 812, as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, communication interface 806, and/or the processing circuitry 802 may be configured to perform any receiving operations and/or certain obtaining operations described herein as being performed by the network node. Any information, data and/or signals may be received from a UE, another network node and/or any other network equipment. Similarly, the antenna 810, the communication interface 806, and/or the processing circuitry 802 may be configured to perform any transmitting operations described herein as being performed by the network node. Any information, data and/or signals may be transmitted to a UE, another network node and/or any other network equipment.

The power source 808 provides power to the various components of network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid, an electricity outlet) via an input circuitry or interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

In an embodiment, the network node 800 implements an interworking logic 130 (and possibly other components) to provide interworking between a cloud platform 120 and a communication service platform, as described herein.

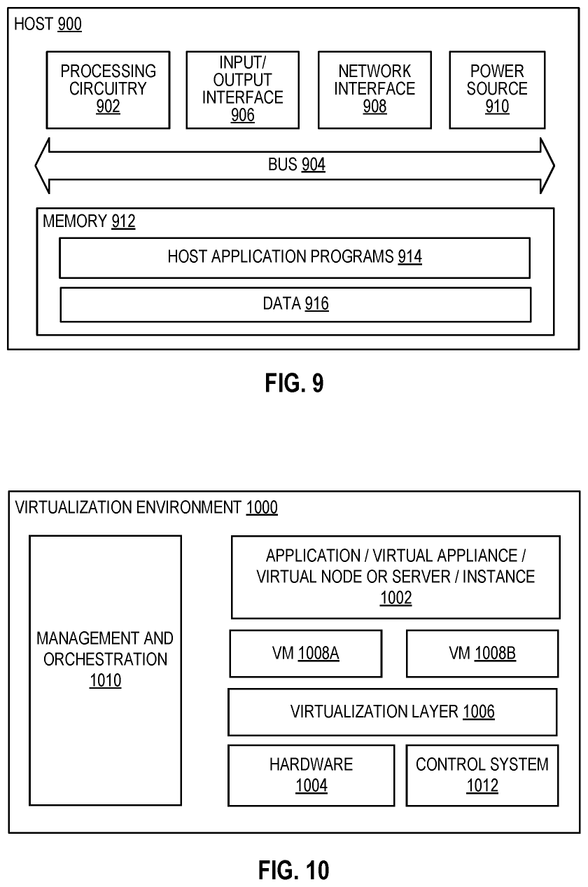

FIG. 9 is a block diagram of a host, according to some embodiments. The host 900 may be an embodiment of the host 616 of FIG. 6, in accordance with various aspects described herein. As used herein, the host 900 may be or comprise various combinations hardware and/or software, including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and a memory 912. Other components may be included in other embodiments. Features of these components may be substantially similar to those described with respect to the devices of previous figures, such as FIGS. 7 and 8, such that the descriptions thereof are generally applicable to the corresponding components of host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 914 may also provide for user authentication and licensing checks and may periodically report health, routes, and content availability to a central node, such as a device in or on the edge of a core network. Accordingly, the host 900 may select and/or indicate a different host for over-the-top services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 10 is a block diagram showing a virtualization environment in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or virtual machine monitors (VMMs)), provide VMs 1008a and 1008b (one or more of which may be generally referred to as VMs 1008), and/or perform any of the functions, features and/or benefits described in relation with some embodiments described herein. The virtualization layer 1006 may present a virtual operating platform that appears like networking hardware to the VMs 1008.

The VMs 1008 comprise virtual processing, virtual memory, virtual networking or interface and virtual storage, and may be run by a corresponding virtualization layer 1006. Different embodiments of the instance of a virtual appliance 1002 may be implemented on one or more of VMs 1008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1008 may be a software implementation of a physical machine that runs programs as if they were executing on a physical, non-virtualized machine. Each of the VMs 1008, and that part of hardware 1004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1008 on top of the hardware 1004 and corresponds to the application 1002.

Hardware 1004 may be implemented in a standalone network node with generic or specific components. Hardware 1004 may implement some functions via virtualization. Alternatively, hardware 1004 may be part of a larger cluster of hardware (e.g., such as in a data center or CPE) where many hardware nodes work together and are managed via management and orchestration 1010, which, among others, oversees lifecycle management of applications 1002. In some embodiments, hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1012 which may alternatively be used for communication between hardware nodes and radio units.

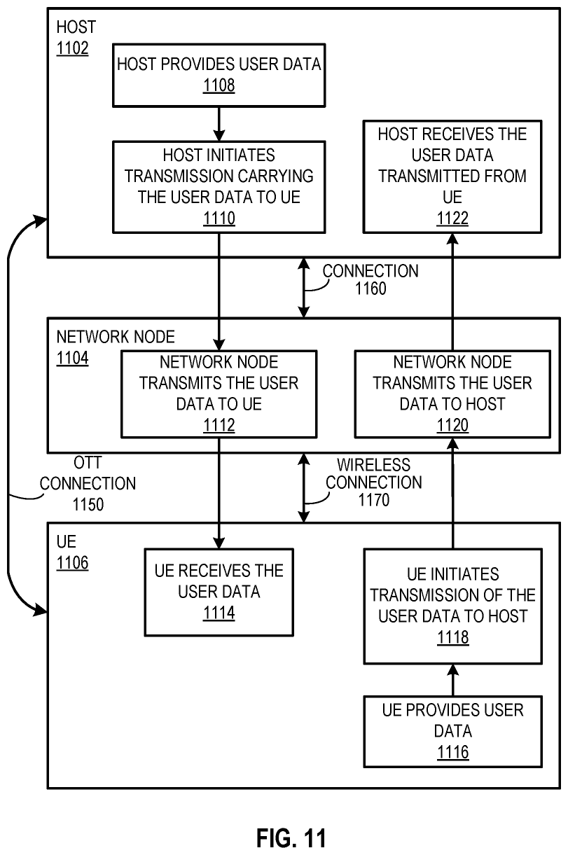

FIG. 11 is a communication diagram showing a host communicating via a network node with a UE over a partially wireless connection, according to some embodiments. Example implementations, in accordance with various embodiments, of the UE (such as a UE 612a of FIG. 6 and/or UE 700 of FIG. 7), network node (such as network node 610a of FIG. 6 and/or network node 800 of FIG. 8), and host (such as host 616 of FIG. 6 and/or host 900 of FIG. 9) discussed in the preceding paragraphs will now be described with reference to FIG. 11.

Like host 900, embodiments of host 1102 include hardware, such as a communication interface, processing circuitry, and memory. The host 1102 also includes software, which is stored in or accessible by the host 1102 and executable by the processing circuitry. The software includes a host application that may be operable to provide a service to a remote user, such as the UE 1106 connecting via an over-the-top (OTT) connection 1150 extending between the UE 1106 and host 1102. In providing the service to the remote user, a host application may provide user data which is transmitted using the OTT connection 1150.

The network node 1104 includes hardware enabling it to communicate with the host 1102 and UE 1106. The connection 1160 may be direct or pass through a core network (like core network 606 of FIG. 6) and/or one or more other intermediate networks, such as one or more public, private, or hosted networks. For example, an intermediate network may be a backbone network or the Internet.

The UE 1106 includes hardware and software, which is stored in or accessible by UE 1106 and executable by the UE's processing circuitry. The software includes a client application, such as a web browser or operator-specific “app” that may be operable to provide a service to a human or non-human user via UE 1106 with the support of the host 1102. In the host 1102, an executing host application may communicate with the executing client application via the OTT connection 1150 terminating at the UE 1106 and host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via a connection 1160 between the host 1102 and the network node 1104 and via a wireless connection 1170 between the network node 1104 and the UE 1106 to provide the connection between the host 1102 and the UE 1106. The connection 1160 and wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104, in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment. More precisely, the teachings of these embodiments may improve the latency (e.g., by provisioning edge subnets at different edge locations that allow for fulfilling application demands) and thereby provide benefits such as reduced user wait times and better responsiveness.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion (e.g., controlling traffic lights). As another example, the host 1102 may store surveillance video uploaded by a UE. As another example, the host 1102 may store or control access to media content such as video, audio, VR or AR which it can broadcast, multicast or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1150 between the host 1102 and UE 1106, in response to variations in the measurement results. The measurement procedure and/or the network functionality for reconfiguring the OTT connection may be implemented in software and hardware of the host 1102 and/or UE 1106. In some embodiments, sensors (not shown) may be deployed in or in association with other devices through which the OTT connection 1150 passes; the sensors may participate in the measurement procedure by supplying values of the monitored quantities exemplified above, or supplying values of other physical quantities from which software may compute or estimate the monitored quantities. The reconfiguring of the OTT connection 1150 may include message format, retransmission settings, preferred routing etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency and the like, by the host 1102. The measurements may be implemented in that software causes messages to be transmitted, in particular empty or ‘dummy’ messages, using the OTT connection 1150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method performed by one or more network devices of a cloud platform for providing interworking between the cloud platform and a communication service platform, the method comprising:
receiving, from a user of the cloud platform, input regarding desired characteristics for an edge cloud;
providing, via an application programming interface, an indication of the desired characteristics for the edge cloud to the communication service platform;
receiving, from the communication service platform via the application programing interface, an indication of a set of edge locations that is capable of supporting the desired characteristics for the edge cloud;
provisioning an edge subnet at each edge location in the set of edge locations; and
making the edge subnets visible to the user of the cloud platform.

2. The method of claim 1, wherein the desired characteristics for the edge cloud include one or more of: a desired geographical location, a desired latency tier, and a desired bit rate tier.

3. The method of claim 1, further comprising:
receiving, from the communication service platform via the application programing interface, a data network name (DNN); and
providing the DNN to the user of the cloud platform.

4. The method of claim 1, further comprising:
creating a domain name system (DNS) record for a fully qualified domain name (FQDN) associated with an application to be deployed in the edge cloud.

5. The method of claim 4, further comprising:
providing the FQDN associated with the application to the communication service platform, wherein the communication service platform is to create a user equipment route selection policy (URSP) rule that associates the FQDN with a network slice associated with the set of edge locations.

6. The method of claim 1, further comprising:
providing a bootstrapping mechanism that is to cause a user equipment route selection policy (URSP) rule to be pushed to a user equipment when the UE accesses an application deployed in the edge cloud.

7. A method performed by one or more network devices of a communication service platform for providing interworking between a cloud platform and the communication service platform, the method comprising:
receiving, from the cloud platform via an application programming interface, an indication of desired characteristics for an edge cloud, wherein the desired characteristics for the edge cloud were provided to the cloud platform by a user of the cloud platform;
determining a network slice that is capable of supporting the desired characteristics for the edge cloud;
determining a set of edge locations associated with the network slice;
creating a user equipment route selection policy (URSP) rule that associates a traffic descriptor with the network slice; and
providing, to the cloud platform via the application programming interface, an indication of the set of edge locations.

8. The method of claim 7, wherein the network slice is determined based on selecting the network slice from a plurality of existing network slices.

9. The method of claim 7, wherein the network slice is determined based on generating a new network slice.

10. The method of claim 9, wherein the new network slice is generated based on network status information obtained from a network status database and/or a network slice template.

11. The method of claim 7, wherein the traffic descriptor is a data network name (DNN).

12. The method of claim 11, further comprising:
providing, to the cloud platform via the application programming interface, the DNN.

13. The method of claim 7, wherein the traffic descriptor is a fully qualified domain name (FQDN) associated with an application to be deployed in the edge cloud.

14. A set of non-transitory machine-readable media having computer code stored therein, which when executed by one or more processors of one or more network devices of a cloud platform, causes the one or more network devices to perform operations for providing interworking between the cloud platform and a communication service platform, the operations comprising:
receiving, from a user of the cloud platform, input regarding desired characteristics for an edge cloud;
providing, via an application programming interface, an indication of the desired characteristics for the edge cloud to the communication service platform;
receiving, from the communication service platform via the application programing interface, an indication of a set of edge locations that is capable of supporting the desired characteristics for the edge cloud;
provisioning an edge subnet at each edge location in the set of edge locations; and
making the edge subnets visible to the user of the cloud platform.

15. The set of non-transitory machine-readable media of claim 14, wherein the desired characteristics for the edge cloud include one or more of: a desired geographical location, a desired latency tier, and a desired bit rate tier.

16. The set of non-transitory machine-readable media of claim 14, wherein the operations further comprise:
receiving, from the communication service platform via the application programing interface, a data network name (DNN); and
providing the DNN to the user of the cloud platform.

17. A set of non-transitory machine-readable media having computer code stored therein, which when executed by one or more processors of one or more network devices of a communication service platform, causes the one or more network device to perform operations for providing interworking between a cloud platform and the communication service platform, the operations comprising:
receiving, from the cloud platform via an application programming interface, an indication of desired characteristics for an edge cloud, wherein the desired characteristics for the edge cloud were provided to the cloud platform by a user of the cloud platform;
determining a network slice that is capable of supporting the desired characteristics for the edge cloud;
determining a set of edge locations associated with the network slice;
creating a user equipment route selection policy (URSP) rule that associates a traffic descriptor with the network slice; and
providing, to the cloud platform via the application programming interface, an indication of the set of edge locations.

18. The set of non-transitory machine-readable media of claim 17, wherein the network slice is determined based on selecting the network slice from a plurality of existing network slices.

19. The set of non-transitory machine-readable media of claim 17, wherein the network slice is determined based on generating a new network slice.

20. The set of non-transitory machine-readable media of claim 17, wherein the traffic descriptor is a data network name (DNN) or a fully qualified domain name (FQDN) associated with an application to be deployed in the edge cloud.
